(19) United States
(12) Patent Application Publication
(10) Pub. No.: US 2023/0357936 A1
(43) Pub. Date: Nov. 9, 2023

(54) METHOD FOR OPERATING AN ELECTROCHEMICAL CELL STACK ARRANGEMENT

(71) Applicant: Hoeller Electrolyzer GmbH, Wismar (DE)

(72) Inventor: Stefan HÖLLER, Lübeck (DE)

(21) Appl. No.: 17/795,253

(22) PCT Filed: Feb. 5, 2020
(86) PCT No.: PCT/EP2020/052832

§ 371 Date: Dec. 2, 2022

(51) Int. Cl. C25B 9/05; C25B 15/023; C25B 13/08; C25B 1/04; C25B 9/77

(52) U.S. Cl. CPC C25B 9/05; C25B 15/023; C25B 13/08; C25B 1/04; C25B 9/77

(57) ABSTRACT

The method serves for operating an electrochemical cell stack arrangement, in particular an electrolyzer, with a stack (2) of electrochemical cells (1) which are arranged between two end plates (3, 4) in a polymer electrolyte membrane construction manner, in particular electrolysis cells (1), concerning which at least one hydraulically impingeable device impinges the cell stack (2) for generating a pressing force. The hydraulic device (8, 9) is hydraulically impinged for generating a pressing force before and/or during the starting operation of the cell stack arrangement, whereupon at least one pressure-leading hydraulic conduit (13, 15) to the device is shut off and the cell stack arrangement is brought into designated operation.

### CROSS REFERENCE TO RELATED APPLICATIONS

This application is a United States National Phase Application of International Application PCT/EP2020/052832, filed Feb. 5, 2020, the entire contents of which are incorporated herein by reference.

### TECHNICAL FIELD

The invention relates to a method for operating an electrochemical cell stack arrangement, in particular of an electrolyzer, with a stack of electrochemical cells which are arranged between two end plates in a polymer electrolyte membrane construction manner, as well as to an electrochemical cell stack arrangement for carrying out this method.

### TECHNICAL BACKGROUND

It is counted as belonging to the state of the art to stack electrochemical cells into stacks, i.e. into so-called stacks which are clamped between so-called end plates and which for example in the form of fuel cells are envisaged for catalytic oxidation of hydrogen amid the generation of electricity or in the form of electrolysis cells in a reverse reaction under the application of electricity for generating hydrogen and oxygen. Herein, typically the hydrogen is stored as an energy carrier. In order to design the generation and storage in an as effective as possible manner, one strives to design the stack such that it can be operated with a high as possible operating pressure, since then one can mostly do without a post-compressing of the generated gas or this can be effected with comparatively little energy expense. The higher the pressure in the electrochemical cells, the higher the forces which act in the stack. These forces are typically accommodated by tie rods which are arranged at the outer sides and in the corners of the mostly cuboid stack and which clamp the electrochemical cells between two end plates. The stack construction is herein such that vertical channels through which the reaction media are fed and discharged are formed next to the actual electrochemical cells. Herein, the electrolysis stack is typically subjected to the throughflow of water and specifically on the one hand in order to lead the starting substance for the electrolysis, specifically water, onto the membranes and on the other hand to cool the cell stack, so that in particular the polymer electrolyte membranes do not overheat or become damaged.

The construction of such a cell stack is counted as belonging to the state of the art and is described for example in DE 10 2015 205 944 and WO 2019/228616 A1, which is referred to inasmuch as this is concerned.

From JP 20031 60891 A, it is counted as belonging to the state of the art, in the case of such an electrochemical cell stack arrangement in the form of an electrolysis stack, to provide a hydraulic device in the form of a piston/cylinder arrangement, with which the cell stack can be impinged by force. For this, a cylindrical recess is formed in an end plate, in which recess a piston can be displaced, said piston bearing on the cell stack in an extensive manner. By way of pressure impingement of this piston/cylinder arrangement by way of feeding a hydraulic fluid, the force which acts upon the cell stack and the sealing force between the individual cells which is herewith effective can be set. In particular, this is important if the pressure within the cell stack increases above a predefined amount, in order to prevent the sealing effect of the seals from reducing. Furthermore, the mechanical pressing of the cells amongst one another is also necessary in order to ensure the electrical connection of the cells which are connected in series.

A disadvantage of this hydraulic pressure impingement on operation is the fact that by way of re-adjusting the hydraulic pressure in dependence on the inner pressure in the stack, a high pressing force is hydraulically produced, which in time can lead to an unallowably high surface pressing being effected in the region of the seals, by which means a flowing of the seals can occur, which negatively influences the long-term sealing characteristics. This in an analogous manner is the case with arrangements concerning which the end plates are clamped by way of the intermediate arrangement of disc spring assemblies and thus ensure that the end plates are equalized given the creep of the seals. This however can lead to a premature damage in the cell stack.

### SUMMARY

Starting from this state of the art, it is an object of the invention to improve a method for operating an electrochemical cell stack arrangement, in particular an electrolysis stack, in particular to prevent the seals from being changed in their designated structure by way of unallowably high surface pressings.

Furthermore, an electrochemical cell stack arrangement is to be provided, with which the method according to the invention can be carried out and with which the initially mentioned problems can be avoided.

The part of this object with regard to the method is achieved by a method with the features which are disclosed herein, and an electrochemical cell stack arrangement for carrying out this method. Advantageous embodiments of the invention are specified in the description and the drawings.

The method according to the invention for operating an electrochemical cell stack arrangement, in particular for operating an electrolysis stack, with a stack of electrochemical cells which are arranged between two end plates in a polymer electrolyte membrane construction manner, for generating a pressing force in the cell stack envisages at least one hydraulically impingeable device, for example a piston/cylinder arrangement. According to the invention, the hydraulic device is hydraulically impinged for generating a pressing force before and/or during the starting operation of the cell stack arrangement. According to the invention, at least one pressure-leading hydraulic conduit to the device is then shut off, whereupon the cell stack arrangement is brought into the designated operation. A pressure-leading conduit in the context of the invention is to be understood as such a conduit with which the hydraulic device is subjected to pressure, given a piston/cylinder arrangement thus typically the conduit which feeds the cylinder and extends the piston given subjection to pressure.

An end plate in the context of the invention does not necessarily need to be understood as a plate-like formation, but in contrast can also have any other suitable shape, in order to support the cell stack to one side and to accommodate the forces which occur in the cell stack in the direction of the stack axis and conversely to exert forces in this direction.

In contrast to the state of the art, the method according to the invention typically envisages a pressure subjection of the hydraulic device before, possible also or alternatively during the starting operation of the cell sack arrangement, thus when the cells stack arrangement is moved to. At the latest, when the cell stack arrangement goes into designated operation, typically however before this, the at least one pressure-leading hydraulic conduit to the device is shut off. Herein, the shutting-off does not necessarily need to be effected in the region of the pressure-leading conduit and this can also be effected at the cylinder side or at another suitable location. Herein, what is essential is that the volume which is located between the cylinder and piston is closed off and cannot be changed further, which means the piston is hydraulically fixed its position. By way of this, it is ensured that independently of the pressure within the cell stack arrangement, the pressure forces which act upon the cell stack do not increase further. In particular, an equalizing of the end plates given a further pressure rise within stack is prevented by way of this method according to the invention, so that an unallowably high surface pressing, in particular in the sealing region is reliably prevented.

The basic concept of the method according to the invention is to hydraulically apply the pressing force which is necessary for the designated operation, onto the cell stack not until directly before starting operation of the cell stack arrangement by way of generating a correspond pressing force and to then shut off the at least one pressure-leading hydraulic conduit which supplies the hydraulic device and generates the pressing force, so the hydraulic device, by way of the pressure-side volume which is then closed is blocked in its movement in the opening direction, but a further force is no longer exerted in the pressing direction. The volume consistency of the hydraulic device which is created by way of this ensures that an equalizing of the device is effectively prevented, which means independently of the pressure conditions which prevail in the cell stack, in particular the seals of the cell stack are not loaded to a greater extent by the pressing force of the hydraulic device. Typically, the generation of the pressing force and hence the pressure impingement of the hydraulic device are effected before starting operation of the cell stack arrangement. Here however, the limits are not fixed and depending on the design the pressure subjection can also be effected in steps or continuously during the starting operation of the cell stack arrangement. It is also conceivable for a first pressure subjection to be effected before starting operation and a further pressure subjection during starting operation. At the latest, when however stable conditions of the electrochemical process have set in within the cell stack, the pressure-leading hydraulic conduit to the device is shut off. By way of this, it is ensured that the volume which is located within the device remains constant and thus no equalizing by the device is effected and thus also no unallowably high surface pressing within the stack arises.

According to an advantageous further development of the invention, one envisages the hydraulic device being pressure-relieved or at least pressure-reduced again after completion of the designated operation. Such electrolysis stacks for example do not run continuously but typically when electricity is inexpensive or is present in excess. By way of this, intervals of use of a duration of hours or also days result. If then the electrochemical process is interrupted or completed, it is advantageous to completely or partly relieve the hydraulic device of pressure, in order to thus reduce the force subjection of the cell stack and thus to ensure that in particular the seals can relax again and according to possibility resume their initial volume, in order to thus be able to exert a high as possible sealing effect over a longer time.

Basically, hydraulic devices as for example piston/cylinder arrangements or cylinder/membrane arrangements or the like can be assumed as being completely sealed, so that a shutting-off of the pressure-leading hydraulic conduit as a rule is sufficient, in order to ensure the volume consistency of the device. According to an advantageous further development of the invention, however by way of suitable measures during the designated operation of the cell stack arrangement one can ensure that the volume which is under pressure in the hydraulic device is kept constant. This can be effected for example by way of a closed-loop control which compensates the volume change by way of thermal expansion of the hydraulic fluid or which compensates hydraulic leakages.

In order to ensure that the pressing force which is generated by the hydraulically impingeable device on the one hand is not too high but on the other hand is sufficiently high, it is advantageous to determine and/or compute the pressure which is to be mustered (generated) for producing the pressing force in the hydraulic devices by way of sensor. The determination by sensor can be effected for example by way of incorporating a force sensor into the stack or between the stack and end plates. The hydraulic pressure which impinges the device can be determined and be controlled or closed-loop controlled according to the previously determined values. Alternatively, the pressure can be increased to such an extent until a predefined distance of the pressing of the stack 2 is achieved.

The hydraulic device which is to be applied for the method must be such which uses the quasi incompressible volume of a fluid as a counter bearing. It is particularly advantageous if the hydraulic device comprises at least one piston-cylinder arrangement with which this is realized.

According to an advantageous further development of the method, herein a hydraulic device is used, said device comprising several hydraulic units, for example piston/cylinder arrangements, which are arranged next to one another and connected in parallel and whose hydraulic conduits are shut off individually or in groups after the pressure subjection for maintaining the pressure force which is necessary on operation. By way of such an arrangement, in particular one can prevent the cell stack, by way of partially increased pressure in part-regions of the stack, from experiencing a greater extension than in others, as could be effected for example given the use of only one piston-cylinder arrangement by way of tilting the piston.

Herein, the parallel connection of the piston/cylinder arrangement is useful in order to ensure that all pistons extend to an equal extent, wherein by way of individual blocking of the hydraulic conduits or group blockings, one can ensure that none of the pistons retract independently of the respective load.

The electrochemical cell stack arrangement according to the invention which is necessary for carrying out the method comprises at least one hydraulic device, typically a piston-cylinder arrangement within the cell stack which can be controlled in accordance with the method according to the invention. It is particularly advantageous if the electrochemical cell stack arrangement, in particular the electrolysis stack which comprises several electrochemical cells, in particular electrolysis cells of the polymer electrolyte membrane construction manner between two end plates comprises a hydraulic device for generating a pressing force upon the cells, which comprises at least two hydraulic units which are arranged next to one another and whose hydraulic conduits can be shut off independently of one another. Herein, these must be pressure-leading hydraulic conduits which can be shut off independently of one another. These hydraulic units can be connected in parallel, so that they commonly extend for generating the pressing force upon the cell stack and can be impinged by the same hydraulic pressure. However, for the volume consistence which is envisaged in designated operation it is necessary to design these hydraulic units in a manner in which they can be shut off independently of one another with regard to their pressure-leading conduits, so that it is ensured that no movement is effected given a different force subjection of the units, which means a counter-bearing which is not changeable for the cell stack is formed.

Given an advantageous embodiment, the cells in a plan view have a roughly rectangular shape, wherein typically tie rods are provided at least in the corner regions and these fasten the end-plates amid the integration of the cell stack. For such an arrangement, it is particularly advantageous to provide four hydraulic units which each impinge a quadrant of the cell stack. These hydraulic units, for example piston/cylinder arrangement can advantageously be shut off individually with regard to their pressure-leading conduits, but can however also be shut off in groups which means that for example two pairs of hydraulic units can be commonly shut-off. The rectangular shape is particularly advantageous since by way of this, as a rule, the economically favorable utilization of the extensive materials can be effected for the construction of the cells. However, cells which are circularly round or polygonal in a plan view are also known and these are constructed into cell stacks between end plates and then further tie rods are typically provided on the peripheral side. Then also four or more or less hydraulic units can be provided in a manner distributed over the surface and these each individually or in groups can be shut off with regard to their pressure-leading conduit.

According to an advantageous alternative of the embodiment according to the invention, given a rectangular cell shape, one envisages arranging five hydraulic units and specifically four which each impinge a quadrant of the cell stack and a central hydraulic unit which centrally impinges the cell stack. Herein, it is advantageous if the central hydraulic unit has a pressure-effective surface which is two to five times larger than the that of the respective other hydraulic units, so that the essential force is generated (mustered) by this central hydraulic unit and a tilting of the piston given the use of a piston/cylinder arrangement as a central hydraulic unit is however effectively prevented by the surrounding smaller hydraulic units.

Particularly advantageously, a hydraulic unit is formed by a hydraulic piston/cylinder arrangement, wherein the cylinder or cylinders can advantageously be formed by one or possibly also both end plates themselves and the pistons are displaceably arranged in these. Herein, the fluid-leading conduit can connect from the rear side of the respective end plate and shut-off valves are advantageously attached directly to the end plate, by which means the hydraulic stiffness of the system is increased. A hydraulic device according to the invention can thus be advantageously formed from hydraulic construction units in the form of piston/cylinder arraignments which are advantageously formed within an end plate or are arranged between the end plate and cell stack.

Alternatively to a piston/cylinder arrangement, a hydraulically impingeable membrane can also be provided as a hydraulic unit. Such a typically metallic membrane as a rule is sufficient in order to be able to accommodate the small linear travel which is necessary for the force impingement.

It is particularly advantageous, in the electrochemical cell stack arrangement according to a further development of the invention, to arrange the hydraulic units in pairs and to render their hydraulic conduits able to be shut off in pairs in accordance with their arrangement. Herein, if a possibly present central hydraulic unit is provided, it is useful to design this in a manner in which it can be shut off separately with regard to its feeding hydraulic conduit.

Advantageously, the hydraulic units are connected in parallel and can be hydraulically impinged in parallel. Such an arrangement has been found to be practical, even if a comparatively large central hydraulic unit is used, said hydraulic unit in comparison to the small hydraulic units generating a significantly larger force given the same pressure.

The invention is hereinafter explained in more detail by way of embodiment examples which are represented in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a greatly simplified schematic sectioned representation showing an electrolysis stack of the PEM construction type in a longitudinal section;

FIG. 2 is a greatly schematic plan view showing a section through the cell stack arrangement according to FIG. 1 in the cylinder region of the end plate;

FIG. 3 is a plan view according to FIG. 2 showing a section of an embodiment with four piston/cylinder arrangements; and

FIG. 4 is a plan view according to FIG. 2 showing a section of an embodiment with five piston/cylinder arrangements.

### DESCRIPTION OF PREFERRED EMBODIMENTS

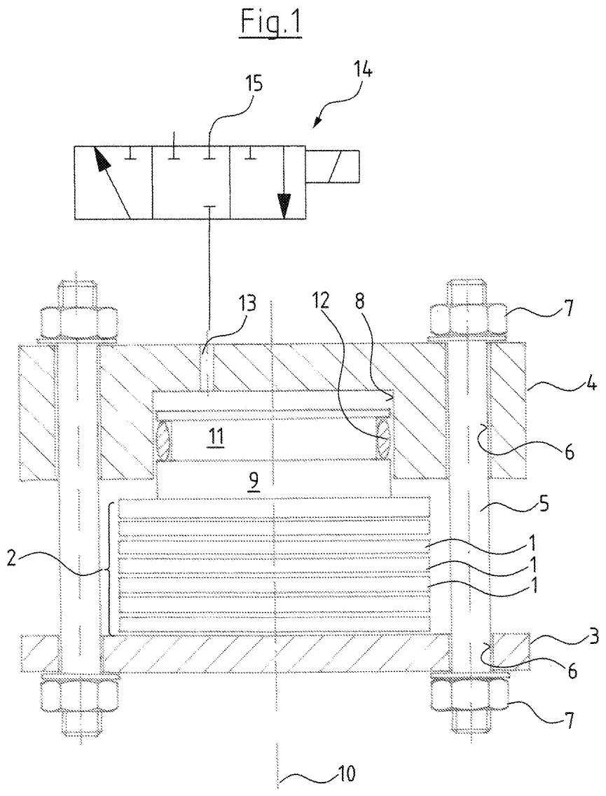

Referring to the drawings, the electrolyzer which is represented in a highly schematic manner in FIG. 1 comprises a number of electrolysis cells 1 of the PEM construction type which are arranged lying upon one another and are connected electrically in series. Only seven electrolysis cells 1 are represented in the drawing and these represent a multitude of electrolysis cells as are known in practise with cells 1 which are arranged by 100 to 250 into a stack. The construction of the cells is counted as belonging to the state of the art and is therefore not described in detail and inasmuch as this is concerned WO 2109/228616 A1 as well as the PCT application of the applicant which is specified under the application file number PCT/EP2019/082449 is referred to.

The channels which are present within the cell stack 2 which is constructed from electrolysis cells, for the feed of water and the discharge and collection of the reaction gases oxygen and hydrogen are not represented. The stack 2 of electrolysis cells of the PEM construction type is clamped between two end plates 3 and 4. The end plates 3 and 4 which laterally project beyond the cuboid stack 2 are provided in the projecting regions with clamping screws 5 which pass through recesses 6 in the end plates and are provided with nuts 7 at the ends, via which the end plates 3, 4 are clamped to one another amid the inclusion of the stack 2.

The end plate 4 which is at the top in FIG. 1 comprises a cylindrical recess 8 which is open towards the stack 2 and in which a piston 9 can be displaced in the direction of the stack axis 10. The piston 9 comprises a peripherally circumferential groove 11 in which a piston ring 12 is integrated, said piston ring sealing the piston 9 with respect to the cylinder wall of the recess 8.

The piston 9 serves for force impingement of the stack 2 and forms a hydraulic device. The cylinder recess 8 is connected through a conduit bore 13 in the face wall of the end plate 4 via a valve 14 to a pressure-leading conduit 15 of a hydraulic supply. The valve 14 is electrically controlled.

Before starting operation of the electrolysis device, the pressure-leading conduit 15 is connected to the cylinder space 8 in the end plate 4 via the valve 14 and the conduit 13, by which means the piston 9 extends and applies a pressing force upon the stack 2. The pressure of the hydraulic supply is controlled such that the pressing force corresponds to a previously determined pressing force. A force sensor or a path measurement device via which the hydraulic pressure which impinges the piston 9 is controlled or closed-loop controlled can possibly be provided between the piston 9 and the stack 2, or the stack 2 and the end plate 3 or between cells 1 of the stack 2. As soon as the force which is applied upon the stack 2 of electrolysis cells 1 for the designated use of the electrolyzer is reached, the valve 14 is brought into the blocking position which is represented in FIG. 1 and in which the conduit 13 is blocked, which is to say is separated from the pressure-leading conduit 15 of the hydraulic supply. Herewith, the volume which is enclosed between the piston 9 and the cylinder recess 8 is fixed which is to say the piston 9 forms a counter bearing for the stack 2 on account of the hydraulic fluid within the cylinder recess 8 and the conduit 13, said hydraulic fluid assumed as being incompressible. The pressing of the stack 2 which is effected by the piston 9, i.e. the squashing of the seals of the cells 1 remains constant irrespective of the pressure conditions within the stack 2.

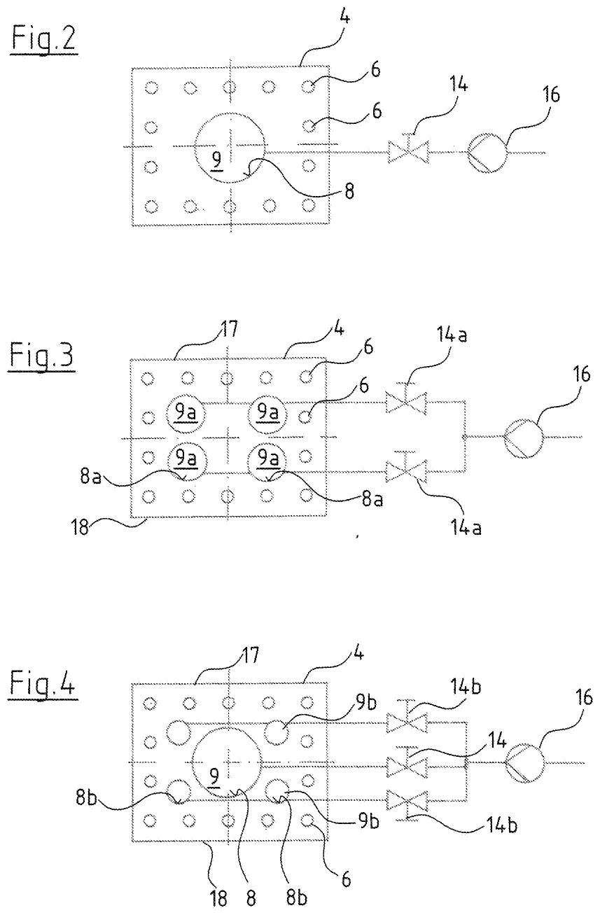

The arrangement with a central piston/cylinder arrangement 8,9, represented and described by way of FIG. 1 is represented schematically in FIG. 2. The shut-off valve is characterised at 14 and the hydraulic supply is symbolised by a hydraulic pump 16. As the figure illustrates, the end plates, of which only one end plate 4 is visible in FIG. 2, have a rectangular shape. The stack 2 of electrolysis cells 1 which is clamped in by way of these likewise has a rectangular shape but in the end plate region is surrounded by a multitude of recesses 6 through which clamping screws 5 are led, these being fixed by way of nuts 7.

Given electrolyzers of the aforedescribed construction type which are operated with a multitude of electrolysis cells 1 at a high pressure, an intensive cooling of the stack is necessary. This is effected by way of water which is pumped from one side 17 into the stack 2 and exits again at the other side 18 of the stack, wherein a small part of this water is converted in the electrochemical process into oxygen and hydrogen. Since this water is pressed into the stack 2 at the input side 17 with an increased pressure, on operation a high force results on the piston 9 at one side 17 of the stack 2 than at the other side 18. Given a piston 9 with a comparatively large diameter, this can lead to this tilting, even if only minimally, by which means the force conditions within the stack 2 can change, which is not desirable since the seals are to be pressed with a constant pressing force over the complete periphery of the stack 2.

In order to avoid this problem, with the embodiment variant which is represented by way of FIG. 3 four hydraulic units in the form of piston/cylinder arrangements 8a, 9a are provided. The four piston/cylinder arrangements 8a, 9a there are subjected to pressure in parallel when the valves 14a are opened, so that the pistons 9a of these piston/cylinder arrangements 8a, 9a each generate the same pressing force. These are then shut off in pairs byway of two valves 14a so that irrespective of the force distribution within the stack 2, a piston 9a functions as a counter bearing in each of the four quadrants of the stack 2. Herein, the paired arranged and connection to the shut-off valves 14a is designed such that the cylinder spaces 8a which are adjacent to the side 17 of the stack 2 are shut off by a valve 14a, whereas the cylinder spaces 8a which are adjacent to the other side 18 are shut off with another valve 14a. The water feed at a high pressure is effected at the side 17, whereas the water discharge at a lower pressure is effected at the side 18. The force which departs from the side 17 within the stack 2 in the direction of the axis 10 is therefore greater than that near the side 18. Since the pistons 8a are arranged in pairs and can be shut off by way of a valve 14a, a counter bearing exists at both sides independently of the force action within the stack 2.

Given the embodiment variant which is represented byway of FIG. 4, apart from a central piston/cylinder arrangement 8, 9 with the cylinder recess 8, four piston/cylinder arrangements 8b, 9b are additionally provided in the corner regions of the stack 2. Herein, the piston/cylinder arrangements 8b, 9b can each be shut off by a valve in pairs as with the embodiment according to FIG. 3, and the central piston/cylinder arrangement 8, 9 likewise via a separate valve 14. Here the piston/cylinder arrangements 8b/9b which are provided in the corner regions of the stack 2 and are with comparatively small diameters serve for forming the necessary counter bearings, in order given a different loading of the stack 2 close to the sides 17 and 18 to avoid a tilting of the piston 9.

While specific embodiments of the invention have been shown and described in detail to illustrate the application of the principles of the invention, it will be understood that the invention may be embodied otherwise without departing from such principles.

### LIST OF REFERENCE NUMERALS

1 electrolysis cell of the PEM construction type
2 electrolysis cell stack, stack
3 lower end plate in FIG. 1
4 upper end plate in FIG. 1
5 clamping screws
6 recesses in the end plates
7 nuts
8 cylinder recess
8a cylinder recesses in FIG. 3
8b cylinder recesses in FIG. 4
9 large piston
9a small piston in FIG. 3
9b small piston in FIG. 4
10 middle longitudinal axis of the stack
11. groove of the piston 9
12 piston ring
13 conduit bore in the end plate 4
14 shut-off valve
14a shut-off valves in FIG. 3
14b shut-off valves for the small piston in FIG. 4
15 pressure-leading conduit
16 hydraulic supply
17 a side of the electrolysis cell stack 2 at which the water is fed
18 other side of the electrolysis cell stack 2 at which the water is discharged

1. A method for operating an electrochemical cell stack arrangement, comprising an electrolyser, with a stack of electrochemical cells which are arranged between two end plates in a polymer electrolyte membrane construction, the method comprising the steps of:
generating a pressing force with at least one hydraulically impingeable device that impinges the cell stack for generating a pressing force, wherein the hydraulic device is hydraulically impinged for generating the pressing force before and/or during a starting operation of the cell stack arrangement; and
shutting off at least one pressure-leading hydraulic conduit to the device and bringing the cell stack arrangement into designated operation.

2. A method according to claim 1, wherein the hydraulic device is relieved of pressure or at least reduced in pressure after completion of the designated operation.

3. A method according to claim 1, wherein a volume which is enclosed under pressure in the hydraulic device is held constant during the designated operation of the cell stack arrangement.

4. A method according to claim 1, wherein pressure which is to be generated in the hydraulic device for generating the pressing force is sensorically determined and/or computed and/or a travel of the pressing of the stack is measured.

5. A method according to claim 1, wherein at least one piston/cylinder arrangement is used as the hydraulic device.

6. A method according to claim 5, wherein several piston/cylinder arrangements which are arranged next to one another and connected in parallel are used as the hydraulic device, wherein the hydraulic device comprises hydraulic conduits of which are shut off individually or in groups after a pressure subjection for generating the pressure force which is necessary on operation.

7. An electrochemical cell stack arrangement, the electrochemical cell stack arrangement comprising:
electrochemical cells comprising electrolysis cells of a polymer electrolyte membrane construction arranged between two end plates and
a hydraulic device for generating a pressing force upon the cells, the hydraulic device comprising at least two hydraulic units which are arranged next to one another and with hydraulic conduits that can be shut off independently of one another wherein the hydraulically device is configured to impinge the cell stack for generating a pressing force before and/or during a starting operation of the cell stack arrangement and to shut off at least one of the hydraulic conduit and bring the cell stack arrangement into designated operation.

8. An electrochemical stack arrangement according to claim 7, wherein the cells in a plan view have an essentially rectangular shape and wherein the hydraulic device comprises additional hydraulic units such that four hydraulic units are provided which each impinge a quadrant of the cell stack.

9. An electrochemical stack arrangement according to claim 7, wherein the cells in a plan view have an essentially rectangular shape and wherein the hydraulic device comprises additional hydraulic units such that five hydraulic units are provided, of which four each impinge a quadrant of the cell stack and a central hydraulic unit centrally impinges the cell stack.

10. An electrochemical cell stack arrangement according to claim 9, wherein the central hydraulic unit comprises a pressure-effective surface which is twice to five times larger than that of the respective other hydraulic unit.

11. An electrochemical cell stack according to claim 7, wherein at least one of the hydraulic units is formed by a hydraulic piston/cylinder unit.

12. An electrochemical cell stack arrangement according to claim 7, wherein at least one of the hydraulic units comprises a hydraulically impingeable membrane.

13. An electrochemical cell stack arrangement according to claim 7, wherein the hydraulic units are arranged in pairs and the hydraulic conduits connected to respective units can be shut off in pairs in accordance with the pair arrangement of the hydraulic units.

14. An electrochemical cell stack arrangement according to claim 7, wherein the hydraulic units are connected in parallel and can be impinged hydraulically.

15. An electrochemical cell stack arrangement according claim 9, wherein:
the four hydraulic units that each impinge a quadrant of the cell stack are arranged in pairs;
four hydraulic conduits are connected to the four hydraulic units that each impinge a quadrant of the cell stack;
the four hydraulic conduits are configured to be shut off in pairs in accordance the pair arrangement of the hydraulic units; and
another of the conduits is connected to central hydraulic unit and is configured to be shut off separately.
